(19) United States
(12) Patent Application Publication
(10) Pub. No.: US 2026/0345418 A1
(43) Pub. Date: Nov. 5, 2026

(54) TORQUE GENERATOR DEVICE

(71) Applicant: IUVO S.R.L, Pontedera (PI) (IT)

(72) Inventors: Luca MORELLI, Pontedera (PI) (IT); Matteo MOISE, Pontedera (PI) (IT); Leandro GIORDANI, Pontedera (PI) (IT)

(21) Appl. No.: 19/117,702

(22) PCT Filed: Oct. 10, 2023
(86) PCT No.: PCT/IB2023/060177

§ 371 Date: Apr. 2, 2025

Related U.S. Application Data
(60) Provisional application No. 63/414,802, filed on Oct. 10, 2022.

(51) Int. Cl. A61H 1/02

(52) U.S. Cl. CPC A61H 1/0274; A61H 2201/1652

(57) ABSTRACT

A torque generator device is configured for a passive exoskeleton that includes a slider-crank mechanism, an actuation mechanism, and a zero-torque range to prevent variations in the torque generated by the actuation mechanism within a specific range. The slider-crank mechanism includes a crank, at least one rod, and a sliding member with a linear guide. The actuation mechanism comprises an elastic member, a cap, and a linear guide that prevents variable deflection of the elastic member.

### CROSS-REFERENCE TO RELATED DISCLOSURES

This application incorporates by reference: International application No. PCT/IB2018/054513, filed on Jun. 19, 2018 and published as WO 2019/016629 A1 on Jan. 24, 2019; International application No. PCT/IB2020/053821, filed Apr. 22, 2020 and published as WO 2020/217191 A1 on Oct. 29, 2020; International application No. PCT/IB2021/057731, filed on Aug. 23, 2021 and published as WO 2022/043862 A1 on Mar. 3, 2022; International application No. PCT/IB2021/059367, filed Oct. 12, 2021 and published as WO 2022/079610 A1 on Apr. 21, 2022; U.S. Patent Application Publication No. 2018/0303699, published on Oct. 25, 2018; U.S. patent application Ser. No. 16/750,352, filed Jan. 23, 2020; and U.S. Design Patent No. 876,654, granted Feb. 25, 2020.

### FIELD OF THE DISCLOSURE

The disclosure relates to a system for a human body in an exoskeleton, and for supporting assistive devices adapted to augment an operator's performance, mitigate repetitive strain injuries, and/or assist in exerting efforts.

### BACKGROUND

The disclosure relates to an exoskeleton system for assisting a user in exerting efforts, wherein the exoskeleton defines at least one axis of rotation to assume a position corresponding to the joint of the operator, and a device carried by the exoskeleton and designed to offset the resistive forces that act on the joint during the effort exerted by the user.

Exoskeletons are useful tools for addressing needs in healthcare and industrial applications. These exoskeletons can give a user improved endurance and stability or provide corrections to an impaired individual's gait by applying mechanical forces to the body in parallel with the user's muscles. These assistive and rehabilitative bionics technologies have the potential to improve quality of life, reduce the incidence of injury, and create a safer, more comfortable, and productive environment. Exoskeletons may be used in other applications such as in the fitness and exercise domain, whereby the exoskeleton may be arranged to provide restrictive or resistive forces during movement to improve the strength and endurance of a user.

Conventional upper-limb exoskeletons are designed to vertically support the arms of an operator and assist in tasks that are to be performed in positions where the arms are raised. An exemplary exoskeleton system is arranged for the upper body, including the shoulder and arms by enhancing performance by reducing forces at the shoulder (e.g., gravitational forces that urge the arms downward), and enabling the user to perform tasks that require shoulder elevation with less effort. The exoskeleton may assist the user in elevating and supporting the user's arms and can reduce physical risks and discomfort from tasks carried out above chest height or overhead. While certain exoskeletons are available, several technical issues hinder the practical use of exoskeletons in the industry. Specific problems include discomfort for passive and active exoskeletons, the device's weight, alignment with human anatomy and kinematics, and detection of human intention to enable smooth movement for active exoskeletons.

Many wearable exoskeletons are not provided with a compact, lightweight torque profile that is capable of obtaining the desired functional requirements for above-chest height and overhead operations. These exoskeletons are often equipped with cumbersome motors, sensors, or actuators and cannot provide a wide range of motion in comparison to the human upper-limb torso. Moreover, most active exoskeletons supporting shoulder and elbow movements are not portable due to the high power-to-weight ratio. Thus, it is challenging to design an active lightweight upper-limb exoskeleton with existing actuator systems.

Some arm supporting exoskeletons are equipped with an actuator that features a spring element and a line element coupled at a junction. In some instances, the line elements may partially wrap around a pulley system to compensate for gravitational forces. However, these exoskeletons can exhibit slip problems and do not feature integrated and distinct stoppage elements to control the movement of the spring and compensating elements. Moreover, exoskeletons that utilize pulley systems work on friction, increasing the chances of a slip, and experience continuous tension in the line element, which causes the line element to stretch. The stretched line element can introduce variation of force and torque and modify the intended angle range and spring position. Additionally, exposed line elements present issues of snagging and getting caught on nearby objects.

Additionally, current wearable exoskeletons provide either obtrusive or assistive action of an exoskeleton and are not well-equipped with a zero-torque range that creates angle boundaries of little to no variation of the actuator position. It would be desirable for an exoskeleton to be equipped with a zero-torque range to suppress the variation of force and torque.

Accordingly, there is a need for improved torque generator device.

The subject matter claimed herein is not limited to embodiments that solve any disadvantages or that operate only in environments such as those described above. Rather, this background is only provided to illustrate examples in one technology where some embodiments described herein may be practiced.

### SUMMARY

Embodiments of the disclosed device, system, and method relate to a passive exoskeleton for relieving a load on a joint, for example, a shoulder, and for providing assistive effort. The present disclosure is directed to a torque generator device, or torque generator system, and method for generating assistive torque for an exoskeleton user. The object of the present disclosure is to provide an improvement over the prior art solution discussed above, in particular from the standpoints of ergonomics and convenience of use, such as weight reduction, compactness, and torque profile with an extended zero-torque range.

The torque generator device comprises a slider-crank mechanism and an actuation mechanism. The slider-crank mechanism is arranged within a first chamber of the housing of the torque generator device. The slider-crank mechanism is composed of a shaft that extends through the housing into the first chamber along a first axis, or shoulder axis. The shaft is fixed to the exoskeleton kinematic structure which aligns the shaft to the shoulder joint of a user. A crank is fixed to the shaft at the first axis and located within the first chamber. A first rod is pivotally connected to the crank, wherein the crank comprises a hard stop, or embedded stop, that blocks the slider-crank mechanism from rotating when a known angle between crank and rod is reached.

The first rod is further pivotally connected to a sliding member that is configured to linearly translate along a first linear guide located within and fixed to the first chamber. The displacement of the sliding member along the linear guide causes the first rod to pivot about the first axis. The length of displacement of the sliding member along the linear guide is determined by the displacement of the actuation mechanism.

A rigid arm, or piston, extends between the slider-crank mechanism and the actuation mechanism. The arm is connected to the sliding member and first rod within the first chamber. The arm extends into the actuation mechanism and is fixed to a cap within the second chamber. The actuation mechanism comprises an elastic or spring-like member arranged around the arm and extending between a closed end of the spring cap and the opening between first and second chambers. The actuation mechanism may comprise a second linear guide arranged within the second chamber to enable the spring cap and elastic member to linearly translate within the second chamber. The linear guide and the cap prevent variable spring deflection, which can lead to inconsistent torque assistance.

In an embodiment the slider-crank mechanism of the torque generator device comprises a zero-torque range and is configured to prevent variation of torque generated by the actuation mechanism within the zero-torque range. In this embodiment, a first rod is pivotally connected to the crank, and a second rod is pivotally connected to the first rod. The second rod is also pivotally connected to a sliding member and arm. In a preferred embodiment, the joint between first and second rods is configured to lay coaxial with the shoulder joint axis for at least one position.

The disclosed torque generator device overcomes the drawbacks of the prior art by utilizing a novel slider-crank mechanism in combination with a secure actuation mechanism. The torque generator device features multiple linear guides and a spring cap to avoid slip problems. The spring cap and spacer help limit and control the mechanical energy provided by the elastic element. The embedded stop included with the crank element also helps control the mechanical energy provided by the system and can be modified with rods to improve the zero-torque range of the exoskeleton system. The rigid arm, or piston, provided by the torque generator device avoid problems presented by the pulley systems and line elements used in the prior art. The slider-crank mechanism and actuation mechanism also avoid variations of force and torque and facilitate controlled angle ranges without variation of the spring position.

These and other aspects of the disclosed torque generator device, as well as the methods of operation and functions of the related elements of structure and the combination of parts, will become more apparent upon consideration of the following description and the appended claims with reference to the accompanying figures, all of which form a part of this specification.

For purposes of summarizing the disclosed torque generator device, certain aspects, advantages, and novel features of the torque generator device have been described herein. It is to be understood that not necessarily all such advantages may be achieved in accordance with any particular embodiment of the torque generator device. Thus, the torque generator device may be embodied or carried out in a manner that achieves or optimizes one advantage or group of advantages as taught herein without necessarily achieving other advantages as may be taught or suggested herein.

### GLOSSARY

As used, the term “anterior” has its ordinary meaning and refers to a location ahead of or to the front of another location. The term “posterior” also has its ordinary meaning and refers to a location behind or to the rear of another location.

The terms “rigid,” “flexible,” “compliant,” and “resilient” may distinguish characteristics of portions of certain features of the torque generator device. The term “rigid” should denote that an element of the exoskeleton or torque generator device, such as a frame or housing, is generally devoid of flexibility. Within the context of features that are “rigid,” it should indicate that they do not lose their overall shape when force is applied and may break if bent with sufficient force. The term “flexible” should denote that features are capable of repeated bending such that the features may be bent into retained shapes or the features retain no general shape, but continuously deform when force is applied.

The term “approximately” means a value within a statistically significant range of value or values, such as the stated length, distance, weight, height, angle, or force.

The terms “substantial” or “substantially” mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. The terms “substantial” or “substantially” mean ±10% in some embodiments, ±5% in some embodiments, and ±1% in some embodiments.

The term “user” refers to a person who uses an orthopedic device. The user may be a patient or an operator.

The term “actuation mechanism” refers to a passive device that does not draw energy from an external power supply. As described herein for exemplary purposes, the actuation mechanism is described as an elastic or spring-like member.

The term “elastic” means being capable of recovering in size and shape after deformation.

The term “slider-crank mechanism” generally refers to a four-link mechanism with three revolute joints and one prismatic, or sliding, joint. As described herein for exemplary purposes, a pre-loaded spring is acting on the rod extremity.

The term “zero-torque range” is used to describe a range of the torque generator device that provides neither obtrusive nor assistive action of an exoskeleton. The zero-torque range means that zero newton-meters (N m), or substantially zero N m, of torque is applied along a limited and predetermined angular range of the shoulder flexion angle. The only torque perceived by the user while the torque generator device operates in the zero-torque range may be friction torques or the torque generated by the weight of the torque generator device.

It will be understood that, unless a term is defined to possess a described meaning, there is no intent to limit the meaning of such term, either expressly or indirectly, beyond its plain or ordinary meaning.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

Further characteristics and advantages of the invention will emerge clearly from the ensuing description referring to the annexed drawings, which are provided purely by way of non-limiting example and in which:

FIG. 1A illustrates a perspective view mainly directed to a posterior aspect of an exoskeleton system, including the torque generator device according to the disclosure.

FIG. 1B illustrates an elevational view direction to an anterior aspect of the exoskeleton on FIG. 1A.

FIG. 1C illustrates a detailed perspective view of the exoskeleton system of FIG. 1A.

FIG. 1D illustrates a posterior aspect of an exoskeleton system having two different torque generator devices.

FIG. 2A illustrates a mechanism configuration for a torque generator device.

FIG. 2B illustrates an alternative mechanism configuration for a torque generator device.

FIG. 3 illustrates human body reference positions implemented with the mechanism configuration of FIG. 2B.

FIG. 4A illustrates a cross-sectional view of the torque generator device.

FIG. 4B illustrates a perspective view of the slider-crank mechanism of the torque generator device of FIG. 4A.

FIG. 5 illustrates human body reference positions implemented with the torque generator device of FIG. 4A.

FIG. 6 illustrates an example curve of the assisting torque that can be supplied by the torque generator device of FIG. 4A.

FIGS. 7A-7C illustrate various positions and settings of the implemented mechanism of the torque generator device of FIG. 4A.

FIG. 8 illustrates a cross-sectional view of an exemplary embodiment of the torque generator device.

FIG. 9 illustrates an example curve of the assisting torque that can be supplied by the torque generator device of FIG. 8.

FIGS. 10A-10C illustrate various positions and settings of the implemented mechanism of the torque generator device of FIG. 8.

### DETAILED DESCRIPTION OF VARIOUS EMBODIMENTS

A better understanding of different embodiments of the disclosure may be had from the following description read in conjunction with the accompanying drawings in which like reference characters refer to like elements.

While the disclosure is susceptible to various modifications and alternative constructions, certain illustrative embodiments are shown in the drawings and are described below in detail. The dimensions, angles, and curvatures represented in the introduced above are to be understood as exemplary and are not necessarily shown in proportion. It should be understood, however, there is no intention to limit the disclosure to the specific embodiments disclosed, but on the contrary, the intention is to cover all modifications, alternative constructions, combinations, and equivalents falling within the spirit and scope of the disclosure. The reference numbers used herein are provided merely for convenience and hence do not define the sphere of protection or the scope of the embodiments.

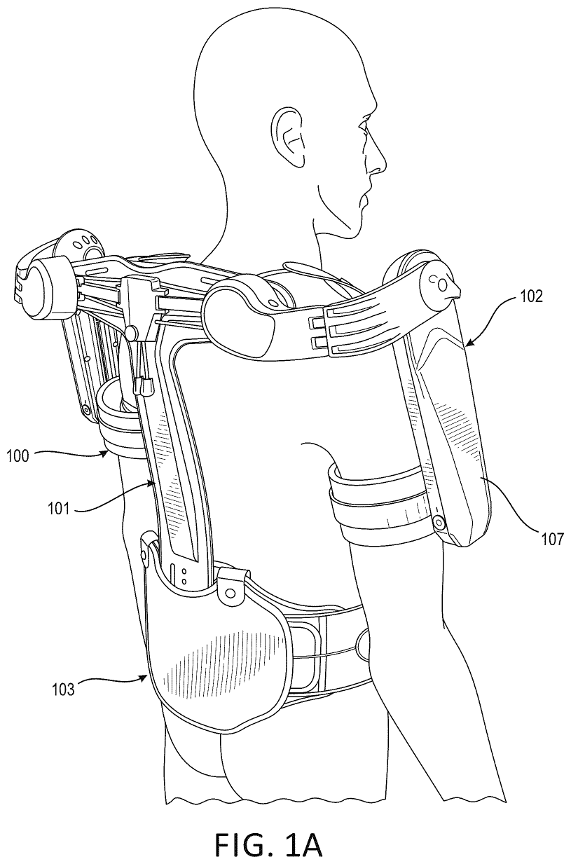

FIGS. 1A-1D illustrate an exoskeleton 100 and torque generator system or assistive system 102 incorporated with an exoskeleton system 100. The exoskeleton system 100 described herein is for assisting a user in exerting efforts and comprises a torque generator device 107 that is designed to offset resistive forces that act on a user's joint. The exoskeleton system 100 and torque generator device 107 described herein have been devised with reference to applications for assisting the user in efforts involving the shoulder joint. The same principles set forth may be applied also for other systems for assisting the operator in efforts involving joint groups or other joints, such as the hip joint or the knee joint.

FIG. 1A illustrates an exoskeleton 100 according to at least according to WO 2022/043862A1, and WO 2022/079610A1. The exoskeleton 100 includes a frame system 101 attached to a lumbar assembly 103 and supporting assistive systems 102. FIG. 1B illustrates the strapping system 129 of the exoskeleton 100, combined with the supporting assistive systems 102. The strapping system 129 includes shoulder straps 130, base arm supports 132, and a waist belt 134.

FIG. 1C shows in perspective view an exoskeleton 100 according to the embodiments. The exoskeleton 100 includes the frame or a frame system 101, and the assistive system 102 comprises one or more of the assistive or torque generator devices 107. Each of the torque generator devices 107 may correspond to an arm of a user and attach to it by an arm cuff 117. The frame system 101 may comprise a vertical strut 105 extending proximate to a user's back and attaching to the user at a lumbar assembly 103, as described in at least U.S. Patent Application Publication No. 2018/0303699, published on Oct. 25, 2018, U.S. patent application Ser. No. 16/750,352, filed Jan. 23, 2020, and U.S. Design Patent No. 876,654, granted Feb. 25, 2020, each document being incorporated herein by reference.

The frame system 101 may comprise a width adjustment feature 109 allowing the torque generator devices 107 to correspond to the width of a user's shoulders. The width adjustment feature 109 may include a slider truck 110 extending horizontally along a horizontally extending strut 106 of the frame system 101 and allowing the torque generator device 107 to be translated in directions D1, and D2. The width adjustment feature 109 may include one or more tensioning elements 121, allowing a user to adjust the width of the torque generator devices 107. For example, a user may apply increased tension to the one or more tensioning elements 121 to draw the torque generator devices 107 in a medial direction D2 or release a degree of tension to allow the one or more torque generator devices 107 to translate in a lateral direction D1, as suitable.

One or more tensioning elements 121 may be formed of any suitable material. In embodiments, the one or more tensioning elements 121 are formed from an elastomeric material, such as natural or synthetic rubbers, silicone, EPDM, nitrile, neoprene, ethylene propylene diene monomer (EPDM), combinations, thereof, and any other suitable material. The one or more tensioning elements 121 may each correspond to a torque generator device 107 and may be provided in substantially symmetric configurations relative to each other for ease and simplicity of use.

An adjustment mechanism 123 provides the desired degree of tension to one or more of the tensioning elements 121. The adjustment mechanism 123 may apply tension to the one or more tensioning elements 121 as described in U.S. patent application Ser. No. 16/750,352, filed Jan. 23, 2020, and incorporated herein in its entirety by reference. The adjustment mechanism 123 may comprise a body through which channels are defined and configured for receiving the one or more tensioning elements 121 into the body. The adjustment mechanism 123 may define a dial 124 arranged for turning in a tensioning direction (in which one or more of the tensioning elements 121 may be tensioned) or in a release direction (in which the tension may be reduced in the one or more tensioning elements 121).

In embodiments, the adjustment mechanism 123 does not utilize a spring or resilient element to apply tension to the one or more tensioning elements 121 or wind the tensioning elements 121 as in a dial-tensioning mechanism. In embodiments, the dial 124 may comprise a screw extending into the body of the adjustment mechanism 123 to clamp or retain the one or more tensioning elements 121 and to prevent movement of the one or more tensioning elements.

A terminal end 128 of the tensioning elements 121 may be pulled to adjust the width of the torque generator devices 107 when the dial 124 is loose to move the first hinge mechanism 112 in a medial direction D2. The terminal end 128 may slide outwardly in a lateral direction D1 under the natural bias of the torque generator devices 107 as desired. In embodiments, the one or more tensioning elements 121 may be substantially inelastic. The terminal ends 128 of the one or more tensioning elements 121 may drop down from the width adjustment feature 109 as another indicia of a width of the torque generator devices 107 and for convenient manipulation of the terminal ends 128.

The slider truck 110 may define indicia 127 that indicate to a user tension in the one or more tensioning elements 121 and width of the torque generator devices for intuitive and accurate adjustment of the one or more tensioning elements such that the first hinge mechanism 112 aligns substantially incident with a user's shoulder. Such features may be important for off-the-shelf production and use of an exoskeleton according to the embodiments of the disclosure and/or in environments where shift workers alternate use of an exoskeleton. Users on a subsequent shift can easily adjust the width of the exoskeleton and associated components based on their dimensions.

While a single adjustment mechanism 123 is shown and described, it will be appreciated that the depicted embodiment is merely exemplary. Multiple parallel adjustment mechanisms 123, each corresponding to a respective tensioning element, may be used as deemed suitable.

One or more hinge components 111, 112, 113, and 115 may be provided to allow the torque generator devices 107 to assist a user in exerting efforts in a plurality of arm and shoulder positions. Each of the one or more hinge components 111, 112, 113, and 115 may correspond to an axis of rotation and shoulder motion. The axes of rotation may be substantially orthogonal to one another. For example, a first hinge axis Al about which the first hinge component 111 is configured to rotate in directions R1, and R2 may facilitate abduction and adduction. The first hinge axis, A1 may extend horizontally through an anterior/posterior plane.

A second hinge axis A2 may extend vertically through the both the first hinge component 111 and second hinge component 115 and may facilitate rotation horizontally in directions R3, and R4 to facilitate internal and external rotation of the shoulder. A third hinge axis, A3 may extend horizontally through the third hinge component 115 to facilitate the shoulder's extension and flexion (i.e., upward and downward movement) in directions R5 and R6. By providing hinge components 111, 115 corresponding to axes A1, A2, and A3 substantially orthogonal to each other, the torque generator devices 107 may be configured to assist a user in exerting effort in a plurality of suitable positions and configurations.

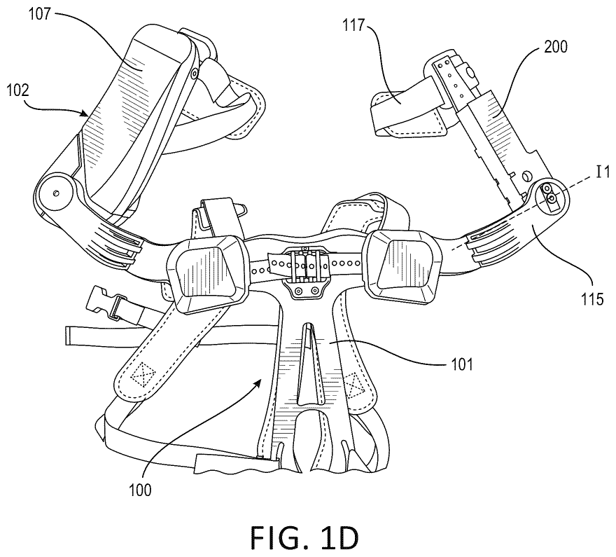

FIG. 1D shows a comparison between the torque generator device 107 and torque generator device 200. The torque generator device 200 is integrated with the exoskeleton system 100 and may be connected to a hinge component 115 of the exoskeleton system 100 at a first axis Il collocated with the shoulder joint of a user. Major advantages obtained from the torque generator device 200 are related to weight reduction, compactness, and an improved torque profile with an extended zero-torque range. In an exemplary embodiment, the weight of the torque generator device is less than 600 g or approximately 500 g. Compared to assist mechanism components of the prior art references incorporated by reference that weigh between 700 g to 900 g, the torque generator device 200 exhibits a weight reduction of 30% to 50%. In an exemplary embodiment, the dimensions of the torque generator device 200 are equal to or less than 170 mm in length, 35 mm in height, and 35 mm in width. The improved torque profile is enabled by a novel slider-crank mechanism. The torque generator device 200 will be described in greater detail below with reference to FIGS. 4-10 .

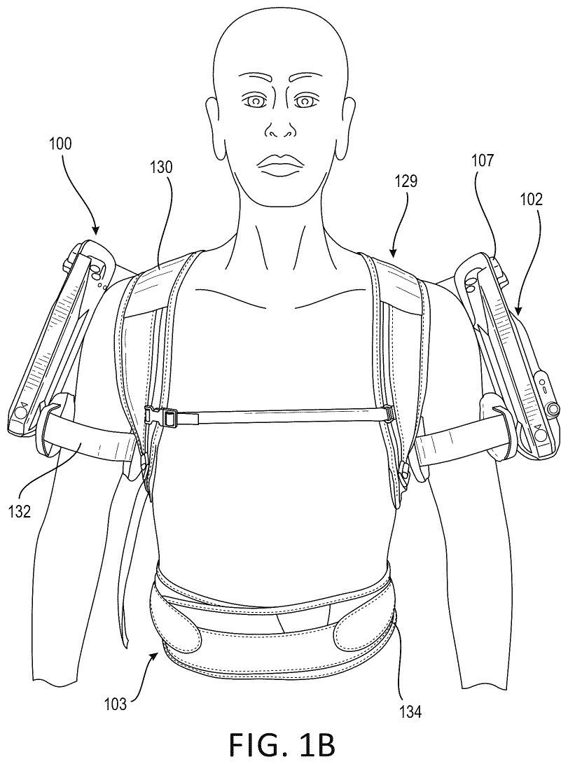

FIG. 2A diagrams the first mechanism configuration 203 to produce the desired level of torque and assistance to a user. Point O is configured to be held in a fixed position on the shoulder joint, such as along first axis I1, by an exoskeleton system 100 and related joints. The crank (r) is fixed substantially vertically above the shoulder, perpendicular to the first axis I1, and connected to a rod (1). Point A represents a spring fixed end position for a spring(s). The mechanism configuration 203 rotates around point O by angle θ with respect to the crank (r).

FIG. 2B diagrams the slider-crank mechanism 205 and actuation mechanism 207 that may be embedded within a housing 202, as observed in FIG. 4A to produce the desired level of torque and assistance to a user. Point O is configured to be held in a fixed position on the shoulder joint, such as along first axis I1, by an exoskeleton system 100 and related joints. The crank (r) is fixed substantially vertically above the shoulder, perpendicular to the first axis I1, and connected to the rod (1). The rod (1) is also connected to an arm (d) that extends in line with the spring(s), and point P represents a spring fixed point.

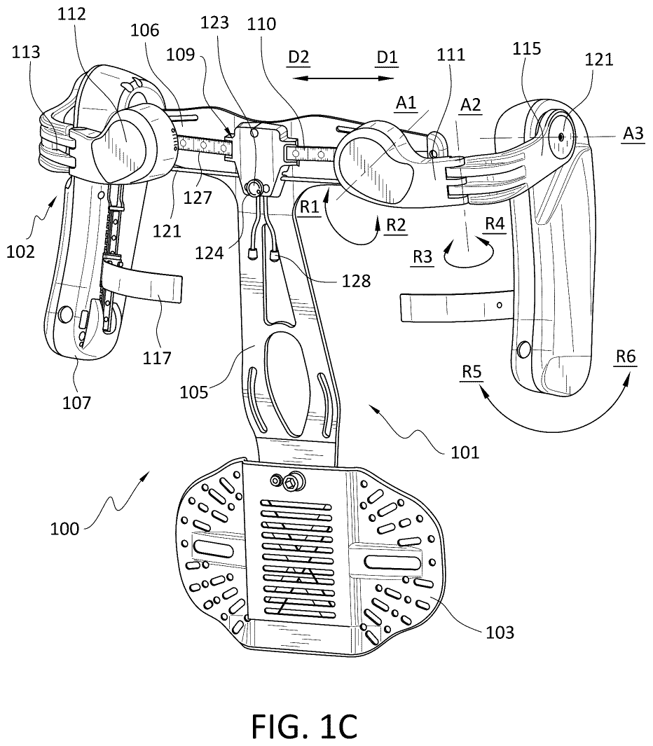

FIG. 3 provides a human body reference for the diagram observed in FIG. 2B. The user's arm is observed in three positions, wherein the user's arm extends along a second axis 12 that is substantially parallel to the upper limb or humerus of a user. The first position P1 depicts the user's arm in a vertical position below the shoulder joint at the first axis I1, said shoulder angle α=0°. In the first position P1, the angle θ between the crank (r) and the second axis 12 about the first axis Il is 180°. The second position P2 depicts the user's arm in a horizontal position anterior to the shoulder joint at the first axis I1, said shoulder angle α=90°. In the second position P2, the angle θ between the crank (r) and the second axis about the first axis I1 is 90°. The third position P3 depicts the user's arm in a vertical position above the shoulder joint at the first axis I1, said shoulder angle α=180°. In the third position, the angle θ between the crank (r) and the second axis 12 about the first axis I1 is 0°.

FIG. 4A illustrates a cross-sectional view of the torque generator device 200. The torque generator device 200 comprises a housing 202 that is configured to enclose the slider-crank mechanism 205 and related elements. In an exemplary embodiment, the dimensions of the housing 202 are equal to or less than 170 mm in length, 35 mm in height, and 35 mm in width. The reduced profile of the housing 202 provides a compact solution for the torque generator device 200 to avoid interferences with elements of the exoskeleton system 100 and other potential obstacles that a user may encounter. The housing 202 has a center of rotation about a first axis I1 that is collocated with the shoulder joint of a user.

The housing 202 comprises a first chamber 204 and a second chamber 206. The first chamber 204 contains components related to the slider-crank mechanism 205 and the second chamber contains components related to the actuation mechanism 207. A shaft 208 extends through the housing 202 and into the first chamber 204 along the first axis I1 and is collocated with the shoulder joint of a user. The housing 202 is fastened to an arm of the user with an external cuff or belt-like device. The housing 202 pivots around the shaft 208 and first axis I1 using at least one bearing member 210. The at least one bearing member 210 may be a rolling-element, such as a bushing, that reduces rotational friction and supports the weight of the torque generator device 200.

The slider-crank mechanism 205 comprises a crank 212 that is rigidly fixed to the shaft 208 within the first chamber 204. The crank 212 is configured to be fixed in a vertical position extending from and above the first axis I1. In one embodiment, the crank 212 is integrally formed with the shaft 208. The crank 212 may be wedge-shaped so that a narrow portion is fixed to the shaft 208 and a wide portion is connected to the first rod 216. The crank 212 comprises an embedded stop 214 that is configured to block the slider-crank mechanism 205 at a desired angle. The embedded stop 214 is blocked by a profile 213 of the first rod 216. In an embodiment, a stoppage 215 that is integrally formed with the housing 202 and within the first chamber 204. In an embodiment, the stoppage 215 may be a separate element from the housing 202 that engages the embedded stop 214 of the crank 212.

The slider-crank mechanism 205 further comprises a first rod 216 that is pivotally connected to the crank 212 at a position apart from and above the first axis I1. The first rod 216 is connected to the crank 212 using a first pin 218 that enables the first rod 216 to pivot with respect to the crank 212. The first rod 216 is further pivotally connected to a sliding member 222 by a second pin 220. The first pin 218 and second pin 220 may be unthreaded mechanical fasteners that are configured to be inserted through preformed openings. The sliding member 222 is connected to a first linear guide 224 that is fixed within the first chamber 204 of the housing 202. The first linear guide 224 enables the sliding member 222 to linearly translate within the first chamber 204 and modify the angle between the crank 212 and the first rod 216.

The torque generator device 200 further comprises a rigid arm 226 that is pivotally connected to both the sliding member 222 and the first rod 216 by the second pin 220. The arm 226 extends through an opening 228 from the slider-crank mechanism 205 in the first chamber 204 to the actuation mechanism 207 in the second chamber 206. The opening 228 may be integrally formed within the housing 202 and have a diameter or periphery that is greater than the diameter or periphery of the arm 226 to permit linear translation of the arm 226 between the slider-crank mechanism 205 and the actuation mechanism 207.

The actuation mechanism 207 produces assistive force from the action of passive elements, such as spring and/or damping elements. The actuation mechanism 207 comprises a spring cap 232 and an elastic member 230. The elastic member 230 may be a resilient spring. The cap 232 comprises an open first end 234 and a closed second end 236 to receive the elastic member 230 and prevents variable spring deflection. The cap 232 is connected to a second linear guide 242 that is fixed within the second chamber 206 of the housing 202. The second linear guide 242 enables the cap 232 to linearly translate within the second chamber 206 and is aligned with within the housing 202 to be substantially parallel to the first linear guide 224. The arm 226 extends through the opening 228 and is fixed to the cap 232. The diameter or periphery of the cap 232 is greater than the diameter or periphery of the opening 228 so as to prevent the actuation mechanism 207 from interfering with the slider-crank mechanism 205. The arm 226 may be adjustable in length along the second axis I2 to enable a variable preload capability for the elastic member 230 of the actuation mechanism 207. In an embodiment, the arm 226 extends through the elastic member 230 and into the cap 232 and is fastened to the second end 236 of the cap 232 by a fastener 238. In an embodiment, the fastener 238 extends through the second end 236 of the cap 232 and into a recess 240 formed by the arm 226. The fastener 238 or similar element may be used to adjust the second end 236 of the cap 232 toward and away from the opening 228 between first and second chambers 204, 206. The second end 236 of the cap 232 may also be displaceable to move toward and away from the first end 234 of the cap 232 and thereby enable variable preload capability for the elastic member 230. In an alternative embodiment, the arm 226 and cap 232 are integrally formed as a unitary, monolithic element.

In an embodiment, the actuation mechanism 207 comprises a regulation spacer 227 arranged within the second chamber 206 and adjacent to the opening 228 to interface with the elastic member 230. The spacer 227 is arranged to change the initial length of the elastic member 230, thus modifying the initial assistance level of the torque generator device 200. As the cap 232 translates along the second linear guide 242, the spacer 227 may also restrict the final length of the elastic member 230. The torque generator device 200 may accommodate one or more replaceable spacers 227 having various, predetermined widths to further modify the assistance levels corresponding to the actuation mechanism 207. In an embodiment, the moveable spacer 227 may be placed within the second chamber 206 adjacent to the second end 236 of the cap 232. The torque generator device 200 may provide for multiple locations for one or more spacers 227 within the second chamber 206, such as within the cap 232, adjacent the second end 236 of the cap, and/or adjacent the opening 228.

FIG. 4B illustrates a perspective view of the slider-crank mechanism 205 of the torque generator device 200 of FIG. 2A. The arm 226 extends along a second axis I2 that is substantially parallel to the upper limb or humerus of a user. In an embodiment, the sliding member 222 may be formed from separate components to attach to the second pin 220 and the first linear guide 224. In an embodiment, the housing 202 comprises at least one protrusion 244 to enclose the housing 202 around the slider-crank mechanism 205.

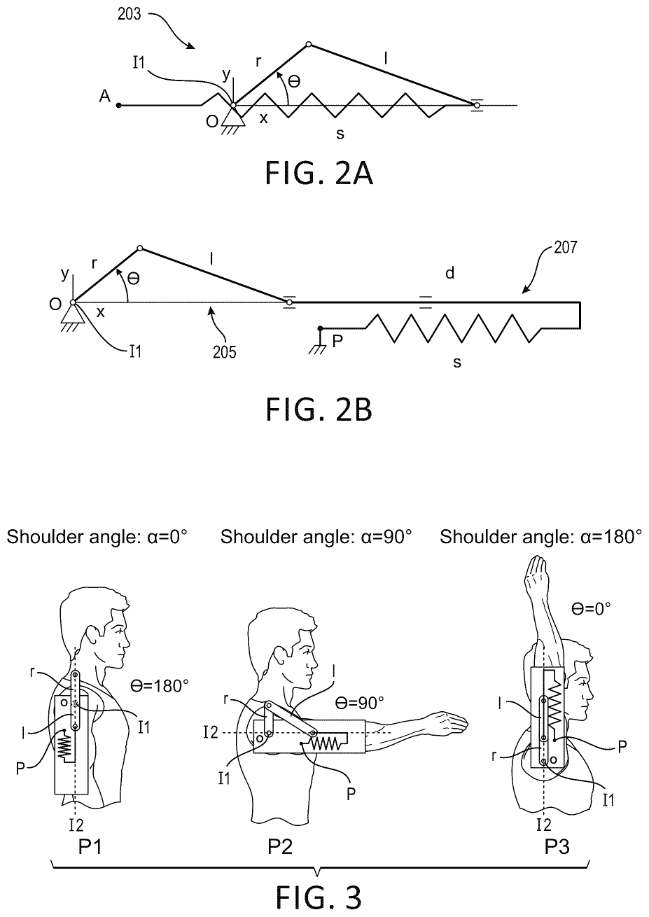

FIG. 5 provides a human body reference for the torque generator device 200 observed in FIG. 4A. The user's arm is observed in three positions, wherein the user's arm extends along a second axis I2 that is substantially parallel to the upper limb or humerus of a user. The first position P1 depicts the user's arm in a vertical position below the shoulder joint at the first axis I1. In the first position, the angle θ between the crank 212 and the second axis I2 about the first axis I1 is 180° and the shoulder angle A is 0°. The second position P2 depicts the user's arm in a horizontal position anterior to the shoulder joint at the first axis I1. In the second position P2, the angle θ between the crank 212 and the second axis about the first axis I1 is 90° and the shoulder angle B is 90°. The third position P3 depicts the user's arm in a vertical position above the shoulder joint at the first axis I1. In the third position P3, the angle between the crank 212 and the second axis I2 about the first axis I1 is zero degrees (0°) and the shoulder angle C is 180°.

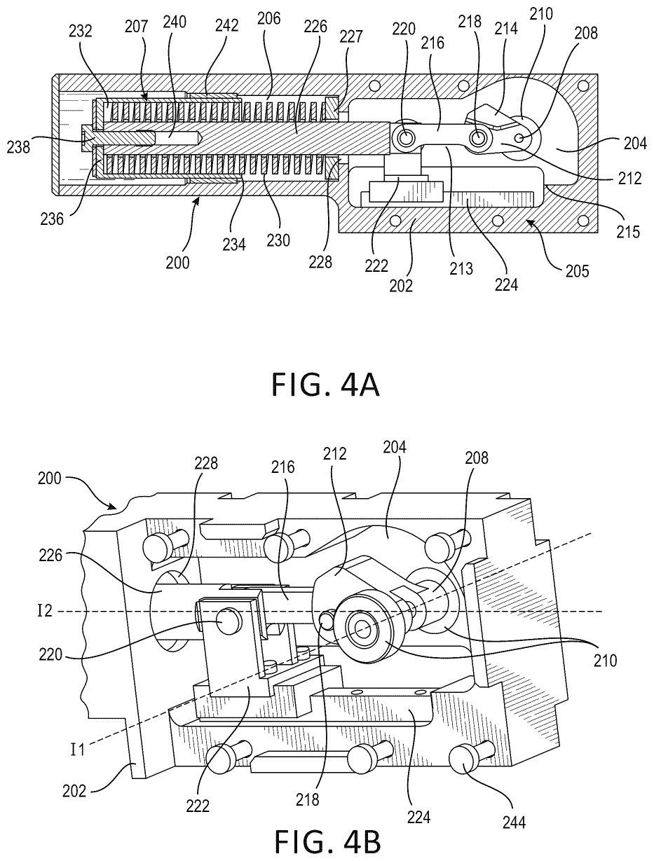

FIG. 6 illustrates the assistance curve, designated by C′, generated by the torque generator device 200. Regarding assistance to the movement of antero-projection of the arm, the torque generator device 200 is capable of providing the best assistance if the maximum torque available is generated at an angle of rotation of 90°. The angle of rotation at 90° is considered to be the most unfavorable position regarding the gravitational moment acting on the arm of the user itself. The device 200 can be prearranged for determining pre-set curves that are optimized for specific requirements of user.

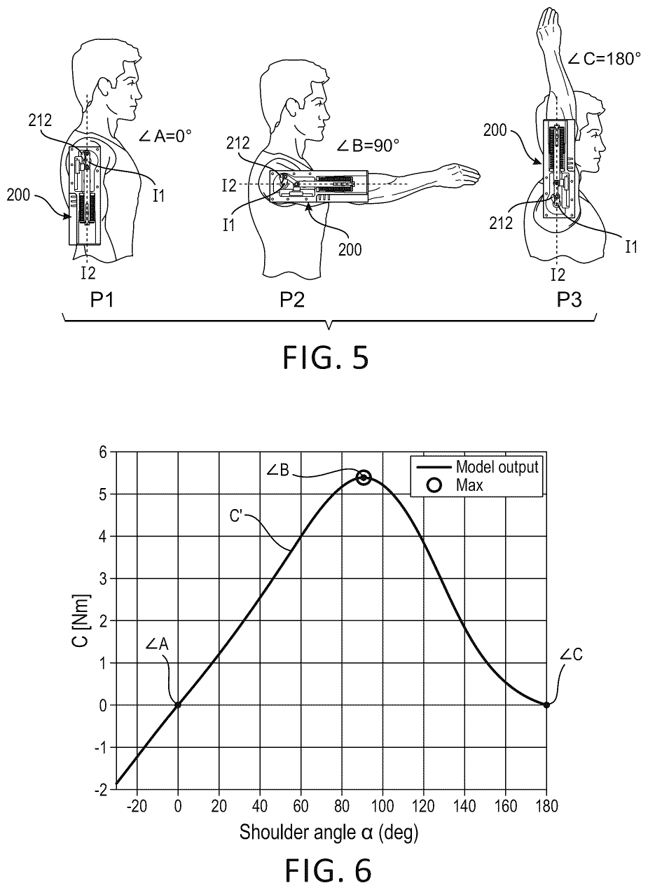

FIGS. 7A-7C illustrate various positions and settings of the implemented mechanism of the torque generator device 200. FIG. 7A provides a first reference position of the crank 212 at the first axis I1 of angle A. Angle A is the angle between the crank 212 and the second axis I2 rotated about the first axis I1. With the torque generator device 200 positioned at angle A, which is understood to be an initial starting shoulder angle of zero (0°) degrees, the crank 212 is vertically positioned above the shoulder joint, or first axis I1, and aligned with the second axis I2, the arm 226 is vertically positioned below the shoulder joint, or first axis I1, and aligned along the second axis I2, and the first rod 216 vertically positioned along the second axis I2. With reference to the user's body, the user's arm is vertically positioned below the shoulder joint, or first axis I1, at angle A. Moreover, FIG. 7A illustrates the first reference position of the sliding member 222 and cap 232 arranged along first and second linear guides 224, 242, respectively. The initial or minimum length, or first length, L1 is understood to be approximately 0 mm, meaning that there is no space between the cap 232 and spacer 227 (or opening 228 when there is no spacer 227). In an embodiment, angle A′ is the angle between the crank 212 and the second axis I2 rotated about the first axis I2 less than zero (0°) degrees before the embedded stop 214 engages the profile 213 of the first rod 216.

FIG. 7B provides a second reference position of the crank 212 at the first axis I1 of angle B. Angle B is the angle between the crank 212 and the second axis I2 rotated about the first axis I2. With the torque generator device 200 positioned at angle B, which is understood to be an angle of 90°, the crank 212 is vertically positioned above the shoulder joint, or first axis I1, the arm 226 is aligned along the second axis I2, and the first rod 216 is offset between the crank 212 and arm 226. With reference to the user's body, the user's arm is horizontally anterior from the shoulder joint, or first axis I1, at angle B. Moreover, FIG. 7B illustrates the second reference position of the sliding member 222 and cap 232 arranged along first and second linear guides 224, 242, respectively. The intermediate length L2 is greater than the first length L1. In an embodiment where angle B is 90°, the intermediate length L2 is half of the maximum length L3.

FIG. 7C provides a third reference position of the crank 212 at the first axis I1 of angle C. With the torque generator device 200 positioned at angle C, which is understood to be a maximum shoulder angle of 180°, the crank 212, first rod 216, and arm 226 are aligned along the second axis I2. With reference to the user's body, the user's arm is vertically positioned above the shoulder joint, or first axis I1, at angle C. Moreover, FIG. 7C illustrates the third reference position of the sliding member 222 and cap 232 arranged along first and second linear guides 224, 242, respectively. The final or maximum length, or third length, L3 that the sliding member 222 may translate along the first linear guide 224 is equal to length L3 between the first end 234 of the cap 232 and spacer 227 (or opening 228 when there is no spacer 227). The length L3 is also representative of the total measure of displacement allowed by the elastic member 230 within the second chamber 206.

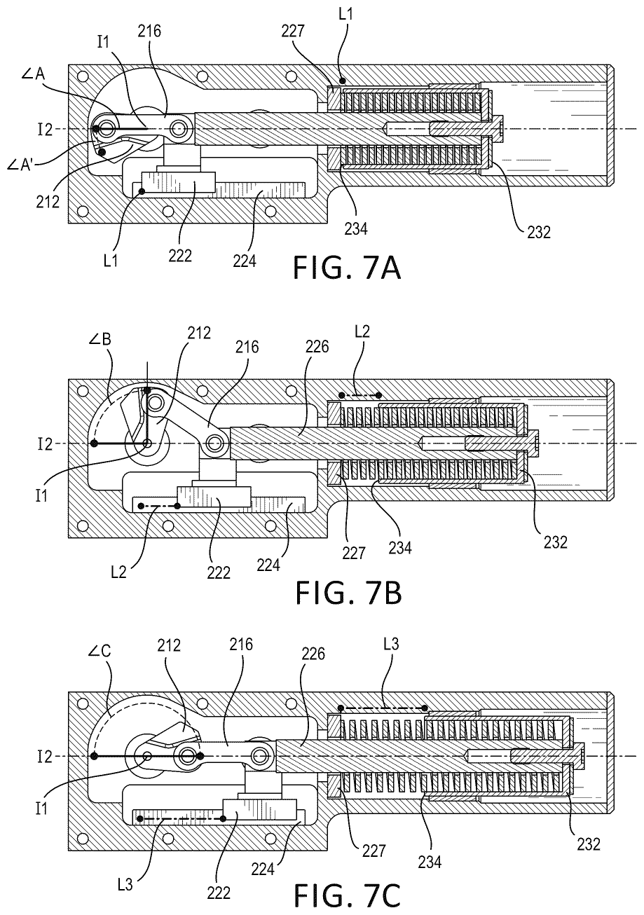

It is to be understood that the torque generator device 300 described in FIGS. 8-10 is an alternative embodiment of torque generator device 200. FIG. 8 illustrates a cross-sectional view of an exemplary embodiment of the torque generator device. The torque generator device 300 comprises a housing 302 that is configured to enclose the slider-crank mechanism 305 and related elements. The housing 302 comprises a first chamber 304 and a second chamber 306. The first chamber 304 contains components related to the slider-crank mechanism 305 and the second chamber contains components related to the actuation mechanism 307. A shaft 308 extends through the housing 302 and into the first chamber 304 along the first axis I1 and is collocated with the shoulder joint of a user. The housing 302 pivots around the shaft 308 and first axis I1 using at least one bearing member 310.

The slider-crank mechanism 305 comprises a crank 312 that is rigidly fixed to the shaft 308 within the first chamber 304. The crank 312 may be fixed at a predetermined angle Z′ in respect to a vertical position extending from and above the first axis I1. The crank 312 comprises an embedded stop 314 that is configured to engage a profile 313 of the first rod 316.

The slider-crank mechanism 305 further comprises a first rod 316 that is pivotally connected to the crank 312 at a position apart from and above the first axis I1. The first rod 316 is connected to the crank 312 using a first pin 318 that enables the first rod 316 to pivot with respect to the fixed crank 312. The first rod 316 is further pivotally connected to a second rod 317 by a second pin 319. At least in one position, the second pin 319 or the joint between first rod 316 and second rod 317 lays coaxial with the shoulder joint of a user, or first axis I1. The second rod 316 is pivotally connected to a sliding member 322 by a third pin 320. The first, second, and third pins 318, 319, 320 may be unthreaded mechanical fasteners that are configured to be inserted through preformed openings to permit rotation of surround components. The sliding member 322 is connected to a first linear guide 324 that is fixed within the first chamber 304 of the housing 302. The first linear guide 324 enables the sliding member 322 to linearly translate within the first chamber 304 and modify the angle between the crank 212 and the first and second rods 316, 317.

The torque generator device 300 further comprises an arm 326 that is pivotally connected to both the sliding member 322 and the second rod 317 by the third pin 320. The arm 326 extends through an opening 328 from the slider-crank mechanism 305 in the first chamber 304 to the actuation mechanism 307 in the second chamber 306. The arm 326 is parallel to both the first linear guide 324 in the first chamber 304 and a second linear guide 342 in the second chamber 306 and translates between the first chamber 304 and the second chamber 306 in a streamlined, linear motion.

The actuation mechanism 307 produces assistive force from the action of passive elements, such as spring and/or damping elements. The actuation mechanism 307 comprises a spring cap 332 and an elastic member 330. The cap 332 comprises an open first end 334 and a closed second end 336 to receive the elastic member 330 and prevent variable spring deflection. The cap 332 is connected to a second linear guide 342 that is fixed within the second chamber 306 of the housing 302. The second linear guide 342 enables the cap 332 to linearly translate within the second chamber 306 and is aligned with within the housing 302 to be substantially parallel to the first linear guide 324. The arm 326 extends through the opening 328 and is fixed to the cap 332. In an embodiment, the arm 326 extends through the elastic member 330 and into the cap 332 and is fastened to the second end 336 of the cap 332 by a fastener 338. In an embodiment, the fastener 338 extends through the second end 336 of the cap 332 and into a recess 340 formed by the arm 326. In an embodiment, the actuation mechanism 307 comprises a regulation spacer 327 arranged within the second chamber 306 and adjacent to the opening 328 to interface with the elastic member 330.

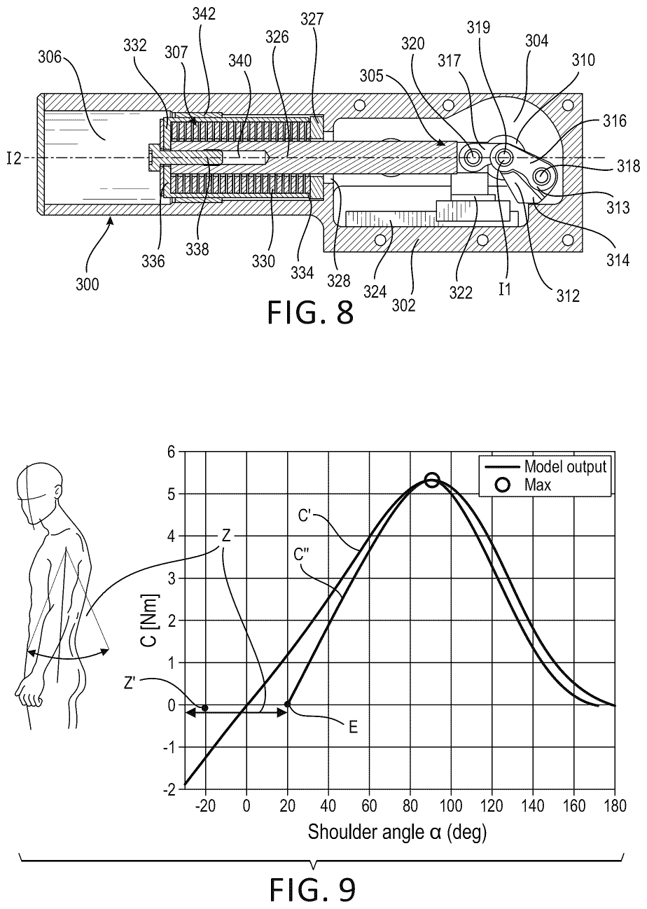

FIG. 9 illustrates the assistance curve C′ generated by the torque generator device 200 and the assistance curve C″ generated by torque generator device 300. The features of the elastic member 330 and the position of the housing 302 can be arranged to obtain an assistance curve C″ that shares the same maximum point with the assistance curve C′. The device 300 can be prearranged for determining pre-set curves that are optimized for specific requirements of user. Because the slider-crank mechanism 305 comprises at least a first rod 316 and a second rod 317, the torque generator device 300 features an angle range Z wherein there is no variation of the elastic member 330 position. This advantageously provides a range with no variation in force or torque.

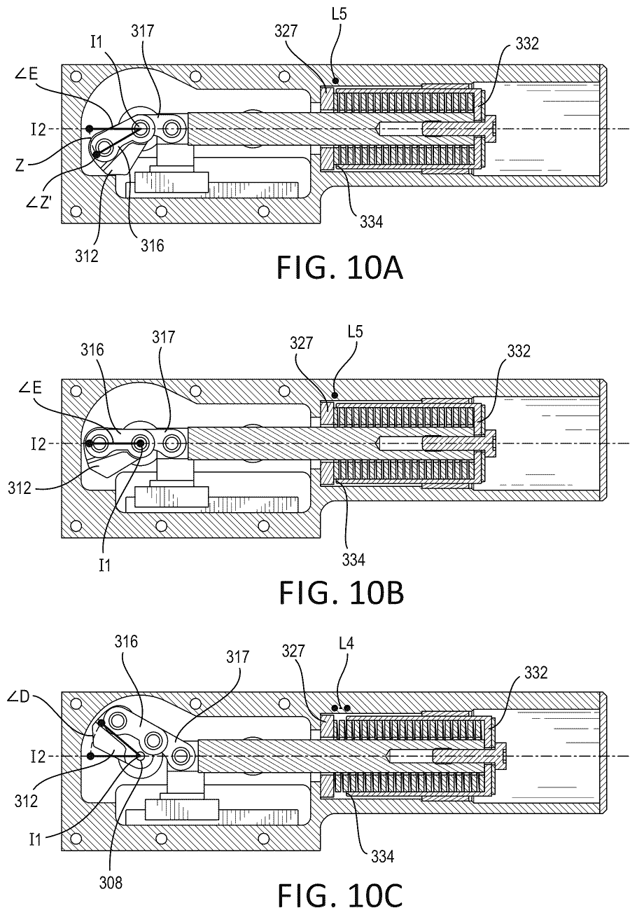

FIGS. 10A-10C illustrate various positions and settings of the implemented mechanism of the torque generator device 300. FIG. 10A provides a first reference position of the crank 312 at the first axis I1 of angle Z′. Angle Z′ is the angle between the crank 312 and the second axis I2 rotated about the first axis I1 by less than 0° to the point where the embedded stop 314 detaches from the profile 313 of the first rod 316. Angle Z′ is less than zero degrees (0°) having a lower limit correlating to the minimum shoulder hyperextension angle of a user. In an embodiment, angle Z may set between −45° to −15°. In an embodiment, angle Z′ is-20°. Angle E is greater than angle Z′. Between angles Z′ and E, the second rod 317 rests on the second axis I2, while the first rod 316 starts its rotation around the first axis I1, resting on the embedded stop 314. This architecture creates an angle range Z between angles Z′ and E with no variation of the spring position, thus no variation of force and torque is observed in angle range Z.

FIG. 10B provides a second reference position of the crank 312 at the first axis I1 of angle E. Angle E is the angle between the crank 312 and the second axis I2 rotated about the first axis I1. With the torque generator device 300 positioned at angle E, which is understood to be a shoulder angle greater than Z′, the first and second rods 316, 317 are positioned along the second axis I2 and the second pin 319, or the joint between first rod 316 and second rod 317, still lays coaxial with the shoulder joint of a user, or first axis I1. Angle E is set to a value greater than zero degrees (0°) and correlates to the angle of In an embodiment, angle E is set between zero degrees (0°) and 40°. In an exemplary embodiment, Angle E is approximately 20°. With reference to the user's body, the user's arm is positioned below the shoulder joint, or first axis I1, at angle E. FIG. 10B illustrates a definitive reference position of the sliding member 322 and cap 332 arranged along first and second linear guides 324, 342, respectively. The starting or minimum length, or first length, L5 is less than the intermediate length L4. L5 is understood to be approximately 0 mm, meaning the there is no space between the cap 332 and spacer 327 (or opening 328 when there is no spacer 327).

FIG. 10C provides a third reference position of the crank 312 at the first axis I1 of angle D. With the torque generator device 300 positioned at angle D, which is understood to be an angle between greater than angle E, the arm 326 is aligned along the second axis I2, and the first and second rods 316, 317 are offset between the crank 312 and arm 326. The first rod 316 and the second rod 317 are both aligned at angle D. FIG. 10C also illustrates an intermediate reference position of the sliding member 322 and cap 332 arranged along first and second linear guides 324, 342, respectively, having an intermediate length L4.

Furthermore, the features and/or components of one embodiment, example, or figure discussed, shown, or suggested hereinabove may be combined with features and/or components of other embodiments, examples, or figures discussed, shown, or suggested herein to provide embodiments, examples, or implementation variations that are not explicitly verbally or visually described or shown herein.

Other configurations of a modified torque profile can be used to incorporate an elastic member, spring cap, linear guides, and rods and cranks configured to rotate and linearly translate in order to compensate for resistive moments that act on a user's joint. The other configurations can also be used to increase mobility of the user and provide an improved zero-toque range for an exoskeleton system as described herein. These and other alternatives will readily occur to the skilled artisan in view of the present disclosure and are encompassed within the subject matter of the present disclosure.

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

1.-20. (canceled)

21. A torque generator device for a passive exoskeleton, the torque generator device comprising:
a slider-crank mechanism arranged within a first chamber defined by a housing; and
an actuation mechanism arranged within a second chamber defined by the housing;
a shaft extending through the housing into the first chamber along a first axis.
a crank fixed to the shaft at the first axis and within the first chamber;
a first rod pivotally connected to the crank, the first rod further being pivotally connected to a sliding member;
a first linear guide located within the first chamber connected to the sliding member, the first linear guide enabling the sliding member to linearly translate within the first chamber.

22. The torque generator device of claim 21, wherein the crank comprises an embedded stop configured to engage a profile of the first rod.

23. The torque generator device of claim 21, further comprising an arm extending through an opening from the first chamber into the second chamber, the arm being connected to the sliding member and a first rod within the first chamber, the arm further extending through an open first end of a spring cap and connected to a closed second end of the spring cap.

24. The torque generator device of claim 23, further comprising a second linear guide arranged within the second chamber, the second linear guide enabling the spring cap to linearly translate within the second chamber.

25. The torque generator device of claim 23, further comprising an elastic member arranged around the arm and extending between the second end of the spring cap and the opening.

26. The torque generator device of claim 25, further comprising a spacer arranged within the second chamber and adjacent the opening, the spacer being configured to change an initial length of the elastic member.

27. A torque generator device for a passive exoskeleton, the torque generator device comprising:
a slider-crank mechanism arranged within a first chamber defined along a first axis and a housing;
an actuation mechanism arranged within a second chamber defined by the housing; and
wherein the slider-crank mechanism comprises a zero-torque range and is configured to prevent variation of torque generated by the actuation mechanism within the zero-torque range;
a crank fixed to a shaft at the first axis and arranged to rotate about the first axis within the first chamber;
a first rod pivotally connected to the crank, a second rod pivotally connected to the first rod, the second rod further being pivotally connected to a sliding member.

28. The torque generator device of claim 27, wherein the crank comprises an embedded stop configured to engage a profile of the first rod.

29. The torque generator device of claim 27, further comprising a first linear guide located within the first chamber connected to the sliding member, the first linear guide enabling the sliding member to linearly translate within the first chamber.

30. The torque generator device of claim 27, further comprising an arm extending between the first chamber and the second chamber, the arm being connected to the sliding member and second rod within the first chamber, the arm further being fixed to a spring cap within the second chamber.

31. The torque generator device of claim 30, further comprising a second linear guide arranged within the second chamber, the second linear guide enabling the spring cap to linearly translate within the second chamber.

32. The torque generator device of claim 30, further comprising an elastic member arranged around the arm and extending between a second end of the spring cap and an opening from the first chamber into the second chamber.

33. The torque generator device of claim 32, further comprising a spacer arranged within the second chamber and adjacent the opening.

34. A torque generator device for a passive exoskeleton comprising:
a slider-crank mechanism arranged within a first chamber defined by a housing;
an actuation mechanism arranged within a second chamber defined by the housing;
a shaft extending through the housing into the first chamber along a first axis;
wherein the slider-crank mechanism comprises a zero-torque range and is configured to prevent variation of torque generated by the actuation mechanism within the zero-torque range;
wherein the zero-torque range extends between the minimum posterior shoulder hyperextension angle of a user and a predetermined anterior flexion angle of a user.

35. The torque generator device of claim 34, further comprising a crank fixed to a shaft at the first axis and arranged to rotate about the first axis within the first chamber;
a first rod pivotally connected to the crank, the first rod further being pivotally connected to a sliding member.

36. The torque generator device of claim 35, wherein the crank comprises an embedded stop configured to engage a profile of the first rod.

37. The torque generator device of claim 35, further comprising a first linear guide located within the first chamber connected to the sliding member, the first linear guide enabling the sliding member to linearly translate within the first chamber.

38. The torque generator device of claim 35, further comprising an arm extending between the first chamber and the second chamber, the arm being connected to the sliding member and second rod within the first chamber, the arm further being fixed to a spring cap within the second chamber.

39. The torque generator device of claim 38, further comprising a second linear guide arranged within the second chamber, the second linear guide enabling the spring cap to linearly translate within the second chamber.

40. The torque generator device of claim 38, further comprising an elastic member arranged around the arm and extending between the second end of the spring cap and an opening from the first chamber into the second chamber;
a spacer arranged within the second chamber and adjacent the opening, the spacer being configured to change an initial length of the elastic member.
